(19) United States
(12) Patent Application Publication
(10) Pub. No.: US 2021/0085150 A1
(43) Pub. Date: Mar. 25, 2021

(54) FLEXIBLE CLEANING APPARATUS

(71) Applicant: Daniel Noriega, Union Hall, VA (US)

(72) Inventor: Daniel Noriega, Union Hall, VA (US)

(21) Appl. No.: 17/024,322

(22) Filed: Sep. 17, 2020

Related U.S. Application Data
(60) Provisional application No. 62/903,708, filed on Sep. 20, 2019.

(51) Int. Cl. A47L 13/38; A47L 13/44

(52) U.S. Cl. CPC A47L 13/38; A47L 13/44

(57) ABSTRACT

A cleaning apparatus for cleaning around an object including a handle having a first end and an opposing second end, a flexible member coupled to the second end of the handle; and a cleaning appendage coupled to the flexible member, wherein flexible member allows the cleaning appendage to move omni-directionally when encountering an object.

### BACKGROUND OF THE INVENTION

### 1. Field of the Invention

The present general inventive concept relates to cleaning apparatuses, and more particularly to a flexible cleaning apparatus designed to clean around an object and conform to irregular surfaces.

### 2. Background of the Invention

Many cleaning tools and implements exist for cleaning objects, surfaces, and spaces. These include brooms, mops, vacuums, and dusters. The utilization of such cleaning implements is well-known. However, such implements, while in use, do not have the ability to conform or flex around objects or obstacles encountered while cleaning. That is, since conventional cleaning tools and implements maintain a rigid shape, users need to constantly adjust a position of the cleaning tool in order to properly clean around various objects encountered while cleaning. As such, this creates difficulty while cleaning, as the cleaning implement cannot properly fit around an object or within a surface or a space, thus resulting in improper or insufficient cleaning.

Accordingly, there is a need for a cleaning tool that can flex around various obstacles or objects encountered during the cleaning process to reduce cleaning time and improve cleaning efficiency.

### BRIEF SUMMARY OF THE INVENTION

The foregoing and/or other aspects of the present general inventive concept may be achieved by providing a cleaning apparatus for cleaning around an object including a handle having a first end and an opposing second end, a flexible member coupled to the second end of the handle, and a cleaning appendage coupled to the flexible member, wherein flexible member allows the cleaning appendage to move omni-directionally when encountering an object.

The flexible member may allow the cleaning appendage to move between an angle of about 0 degrees to about 270 degrees.

Each cleaning appendage may include a slit extending along a longitudinal axis configured to detachably affix a cleaning pad. The first end of the handle may include a loop for hanging.

The handle may include a middle section having a width larger than a width of the first and second ends of the handle.

The foregoing and/or other aspects of the present general inventive concept may be achieved by providing a cleaning apparatus for cleaning around an object including a handle having a first end and an opposing second end, a slit disposed within the handle, a lock disposed with the slit and movable between a first position and a second position, a flexible member coupled to the second end of the handle, and a cleaning appendage coupled to the flexible member, wherein flexible member allows the cleaning appendage to move omni-directionally when the lock is disposed at the second position.

The flexible member may allow the cleaning appendage to move between an angle of about 0 degrees to about 270 degrees.

Each cleaning appendage may include a slit extending along a longitudinal axis configured to detachably affix a cleaning pad.

The handle may include a middle section having a width larger than a width of the first and second ends of the handle.

A movement of the cleaning appendage may be restricted when the lock is in the first position.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device.

It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

FIG. 1 is a top perspective view of a flexible cleaning apparatus according to an example embodiment of the present general inventive concept;

FIG. 2 is a right-side view of the flexible cleaning apparatus of FIG. 1;

FIG. 3 is a top view of the flexible cleaning apparatus of FIG. 1;

FIG. 4 is a front perspective view of the flexible cleaning apparatus of FIG. 1;

FIGS. 5A-5E are top views of the flexible cleaning apparatus of FIG. 1, while cleaning around an object;

FIG. 6 is a top perspective view of a flexible cleaning apparatus according to another example embodiment of the present general inventive concept;

FIG. 7 is a top view of the flexible cleaning apparatus of FIG. 6;

FIG. 8 is a cross-section of FIG. 7 taken along line A-A in FIG. 7, in a first state;

FIG. 9 is a cross-section of FIG. 7 taken along line A-A in FIG. 7, in a second state;

FIG. 10 is a top perspective view of a flexible cleaning apparatus coupled to a cleaning pad according to another example embodiment of the present general inventive concept;

FIG. 11 is a side view of the flexible cleaning apparatus of FIG. 10;

FIG. 12 is a top view of the flexible cleaning apparatus of FIG. 10;

FIG. 13 is a top perspective view of a flexible cleaning apparatus according to another example embodiment of the present general inventive concept;

FIG. 14 is a top view of the flexible cleaning apparatus of FIG. 13;

FIG. 15 is an enlarged detail view of section A in FIG. 14; and

FIGS. 16A-16B are top views of the flexible cleaning apparatus of FIG. 13, while cleaning around an object.

### DETAILED DESCRIPTION OF INVENTION

Reference will now be made in detail to the example embodiments of the present general inventive concept, examples of which are illustrated in the accompanying drawings, wherein like reference numerals refer to the like elements throughout. The exemplary embodiments are described below to explain the present general inventive concept by referring to the figures.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

Various embodiments of the present general inventive concept provide a flexible cleaning apparatus for cleaning around an object or conforming to an irregular surface. For instance, in example embodiments, the present general inventive concept provides an assembly that includes a spring to allow for conforming to an object or surface while cleaning.

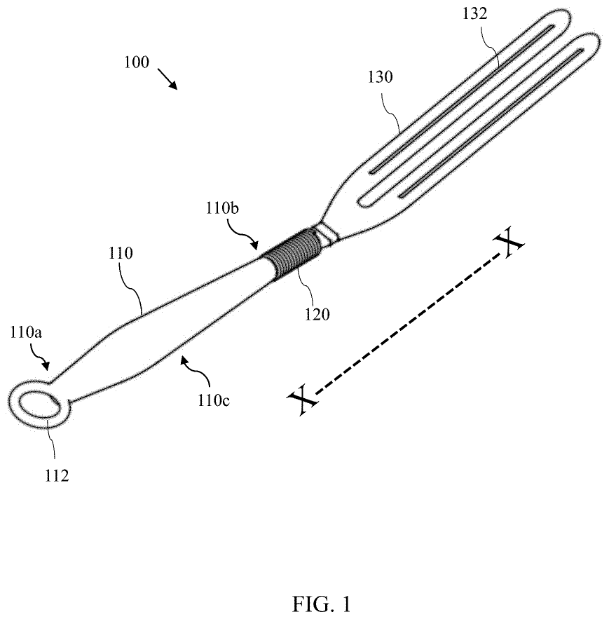

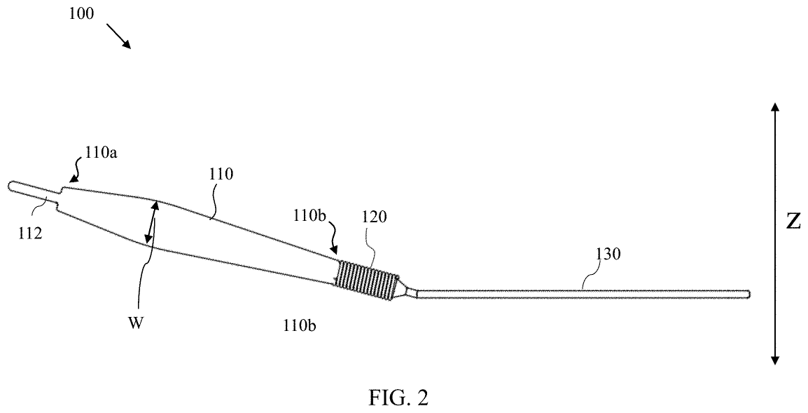

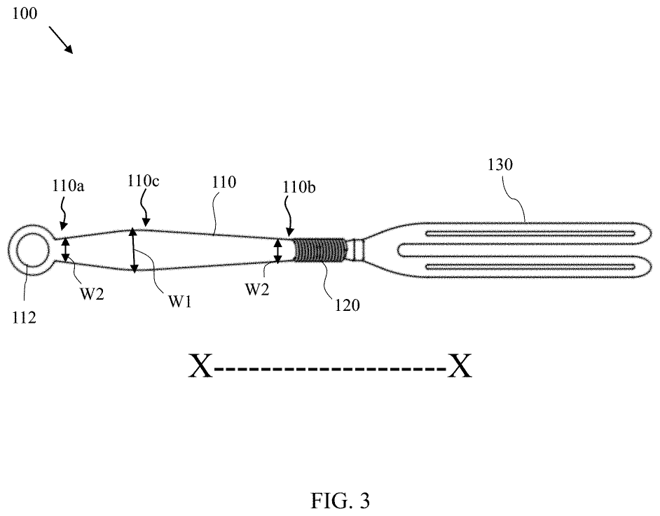

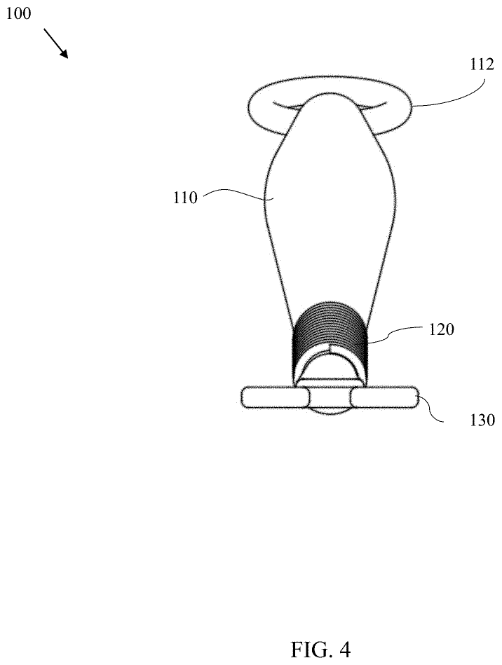

FIG. 1 is a top perspective view of a flexible cleaning apparatus 100 according to an example embodiment of the present general inventive concept, FIG. 2 is a right-side view of the flexible cleaning apparatus 100 of FIG. 1, and FIG. 3 is a top view of the flexible cleaning apparatus 100 of FIG. 1. FIG. 4 is a front perspective view of the flexible cleaning apparatus 100 of FIG. 1.

Referring to FIGS. 1-4, in an example embodiment of the present general inventive concept, the flexible cleaning apparatus 100 includes a handle 110 having a first end 110a and an opposing second end 110b, a flexible member 120 coupled to the second end 110b of the handle 110, and a cleaning appendage 130 coupled to the flexible member 120.

In the present embodiment, the handle 110 is held, for instance, by a hand of a user during cleaning. The handle 110 further includes a loop 112 disposed at the first end 110a of the handle 110 to allow for hanging of the flexible cleaning apparatus 100, for instance on a tack on a wall, or on a peg of a rack.

In the present embodiment, the handle 110 includes a middle section 110c that includes a width W1 that is wider than a width W2 of both the first end 110a and the second end 110b of the handle 110 to provide a more ergonomic grip for a user during a cleaning process.

In the present embodiment, the flexible member 120 includes a spring which allows the cleaning appendage 130 flex, tilt, bend, and/or move with respect to the handle 110.

In the present embodiment, the cleaning appendage 130 extends away from the second end 110b of the handle 110, along a common axis X-X. The cleaning appendage 130 may be configured to be detachably coupled to various cleaning tools, including a mop, a pad, a dusting pad, or the like. However, the present general inventive concept is not limited thereto.

In the present embodiment, the flexible member 120 is flexible to allow the cleaning appendage 130 to flex around an object or obstacle encountered during a cleaning process.

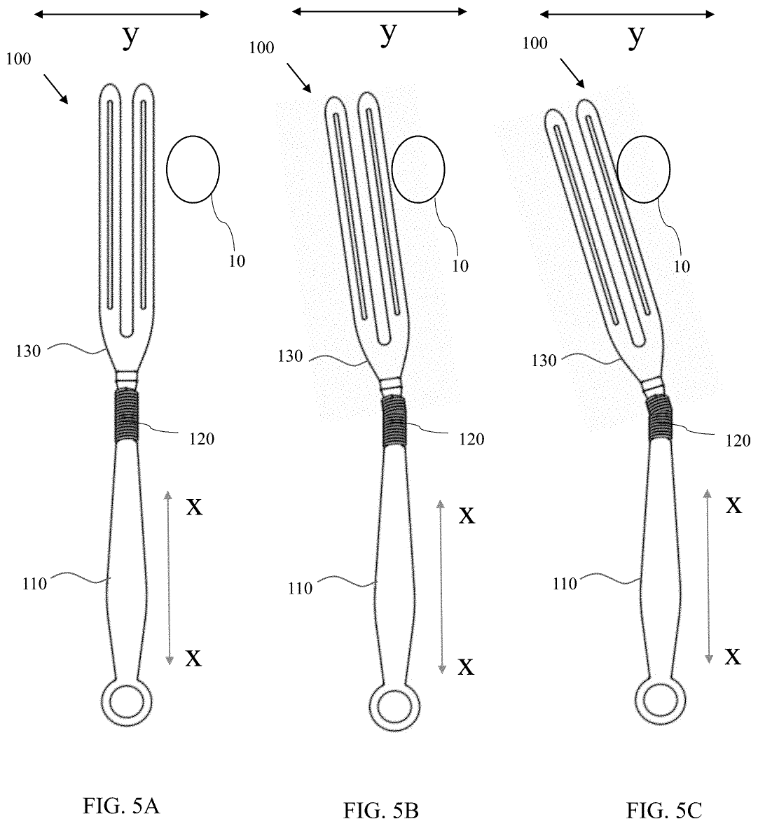

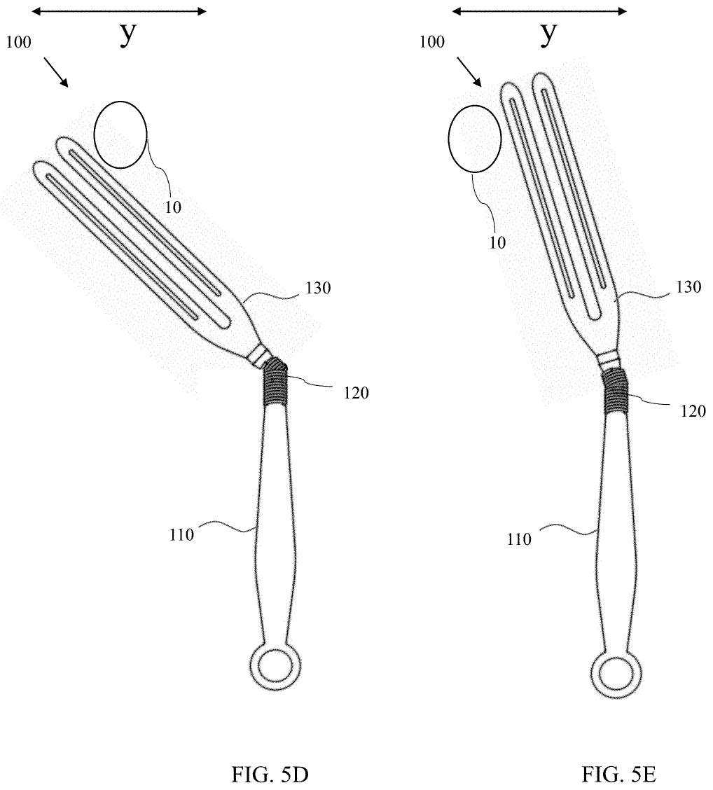

FIGS. 5A-5E are top views of the flexible cleaning apparatus 100 of FIG. 1, while cleaning around an object 10.

Referring to FIGS. 5A-5E, in operation, the flexible member 120 is designed and configured to flex approximately between an angle of about 0 degrees to about 270 degrees to clean around an object 10. However, the present general inventive concept is not limited thereto.

In the present embodiment, the flexible member 120 deflects to allow the cleaning appendage 130 to be disposed at an angle (e.g., from about 0 degrees to about 270 degrees) from the common axis X-X, and thus flex around the object 10 during a cleaning process, as depicted in FIGS. 5A-5E.

The flexible member 120 is flexible in both a y-direction (FIGS. 5A-5E) and a z-direction (FIG. 2). Thus, the flexible cleaning apparatus 100 achieves cleaning around awkwardly shaped objects and irregular surfaces, rendering the flexible cleaning apparatus 100 more ergonomic than traditional implements used for cleaning.

In an example embodiment, the spring rate is such that the spring 120 maintains a balance between rigidity and flexibility. This allows the spring 120 to not be to stiff so as to over-restrict the spring 120 from flexing, but also to not be to flexible so as to be unable to maintain position during cleaning. The spring 120 also has a minimum toughness to keep from breaking or snapping during use.

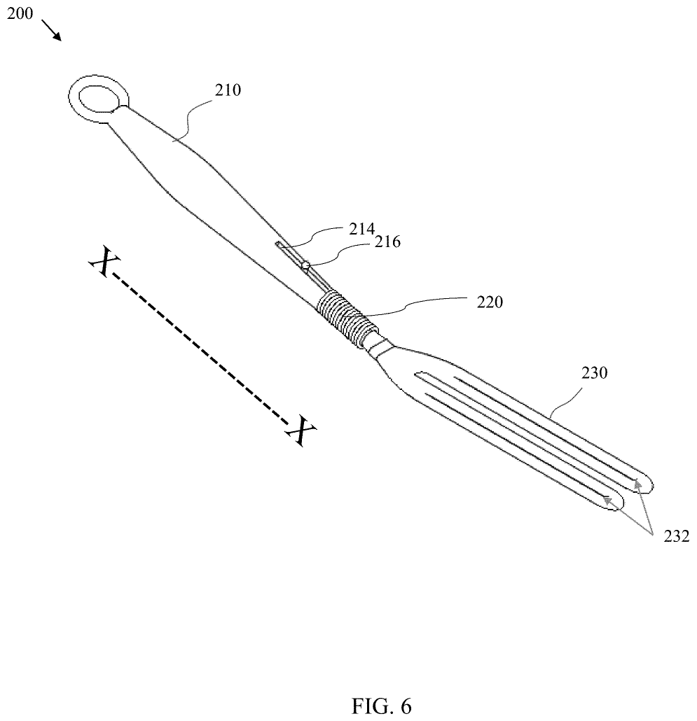

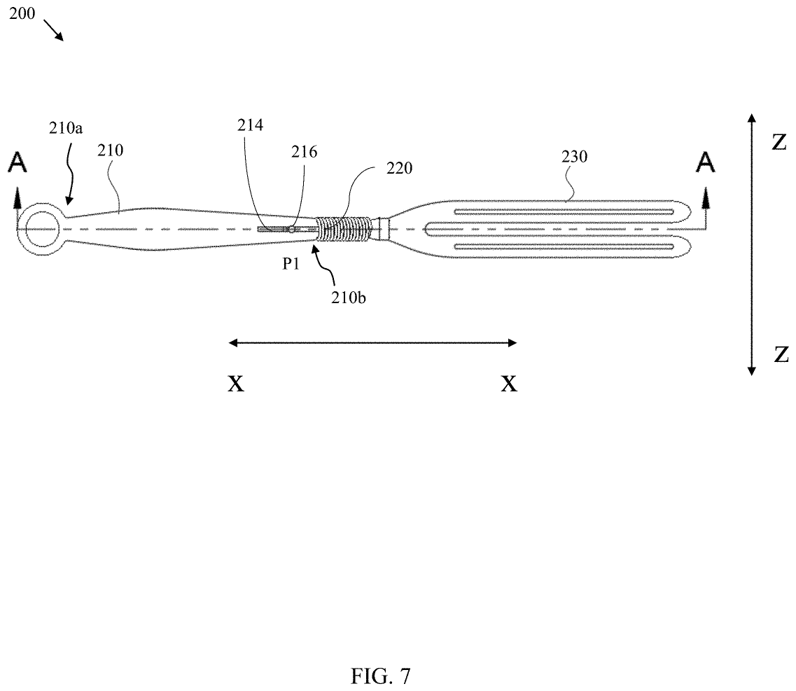

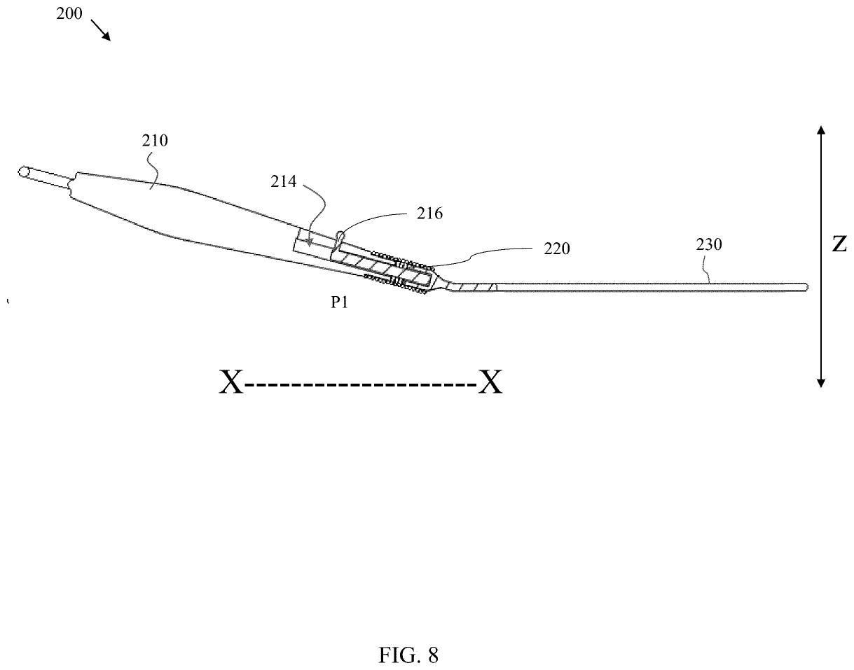

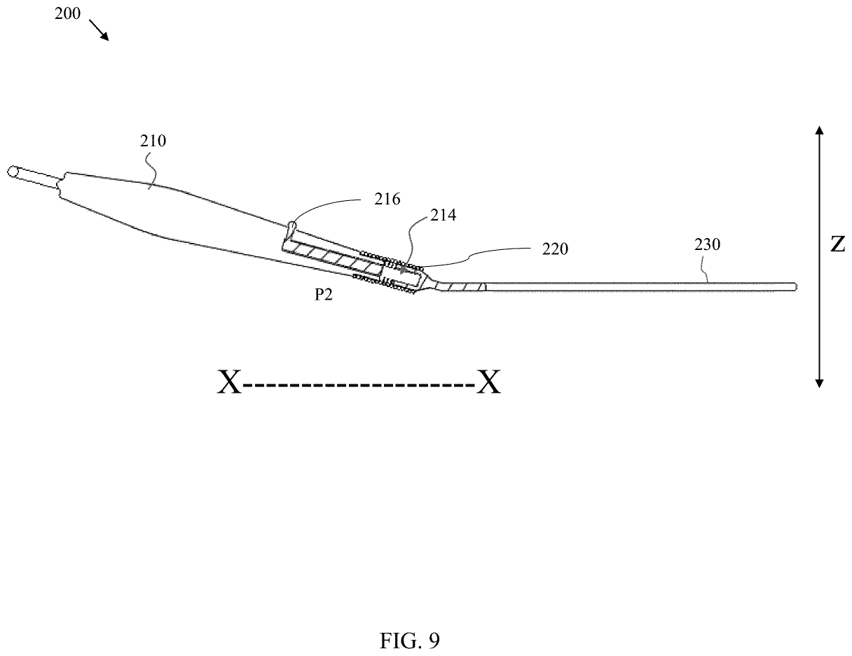

FIG. 6 is a top perspective view of a flexible cleaning apparatus 200 according to another example embodiment of the present general inventive concept and FIG. 7 is a top view of the flexible cleaning apparatus 200 of FIG. 6. FIG. 8 is a cross-section of FIG. 7 taken along line A-A in FIG. 7, in a first state and FIG. 9 is a cross-section of FIG. 7 taken along line A-A in FIG. 7, in a second state.

Referring to FIGS. 6 and 7, the present example embodiment of the flexible cleaning apparatus 200 includes the features of the previous embodiment and further includes a slidable locking mechanism to secure the cleaning appendage in a fixed position.

That is, referring to FIGS. 6-7, the flexible cleaning apparatus 200 includes a handle 210 having a first end 210a and an opposing second end 210b, a flexible member 220 coupled to the second end 210b of the handle 210, and a cleaning appendage 230 coupled to the flexible member 220.

In the present embodiment, referring to FIGS. 8 and 9, the flexible cleaning apparatus 200 further includes a slit 214 disposed within the handle 210 along the common axis X-X. A lock 216 movable between a first position and a second position disposed within the slit 214 of the handle 210.

As illustrated in FIG. 8, when the lock 216 is in a first position P1, the spring 220 remains in a locked rigid state. In the locked state, the spring 220 retains the cleaning appendage 230 along the common axis X-X, Y-Y, and Z-Z, with no movement in the y-direction or the z-direction.

As illustrated in FIG. 9, when the lock 216 is moved from the first position P1 (FIG. 8) to a second position P2 (FIG. 9), the spring 220 is in a free state along the common axis X-X, axis Z-Z, and axis Y-Y. The free state allows the cleaning appendage 230 to flex around the object 10 and into areas that are otherwise difficult to reach during a cleaning process.

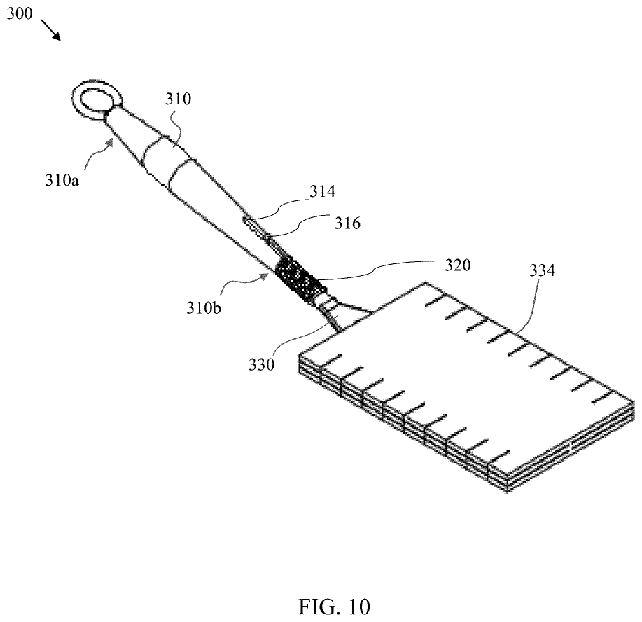

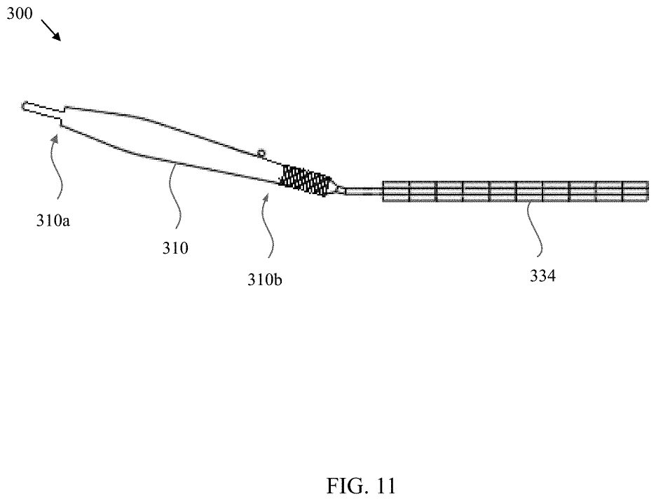

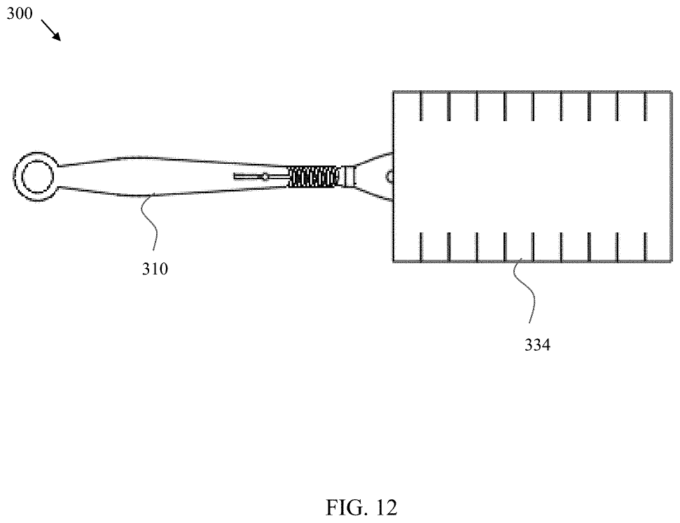

FIG. 10 is a top perspective view of a flexible cleaning apparatus 300 coupled to a cleaning pad 334 according to another example embodiment of the present general inventive concept, FIG. 11 is a side view of the flexible cleaning apparatus 300 of FIG. 10, and FIG. 12 is a top view of the flexible cleaning apparatus 300 of FIG. 10.

The present example embodiment includes the features of the previous embodiments and further includes a detachably coupled cleaning pad.

That is, referring to FIGS. 10-12 the flexible cleaning apparatus 300 includes a handle 310 having a first end 310a and an opposing second end 310b, a flexible member 320 coupled to the second end 310b of the handle 310, and a cleaning appendage 330 coupled to the flexible member 320.

In the present embodiment, referring to FIG. 10, the flexible cleaning apparatus 300 further includes a cleaning pad 334 detachably affixed to the cleaning appendage 330.

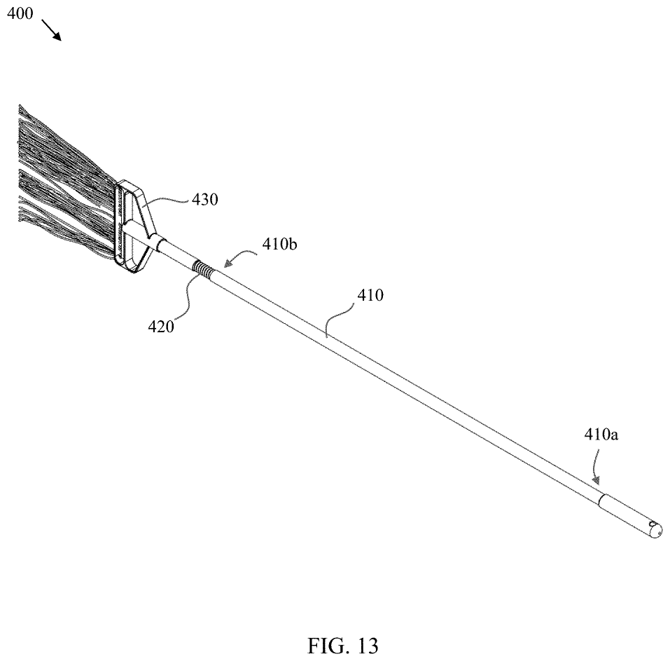

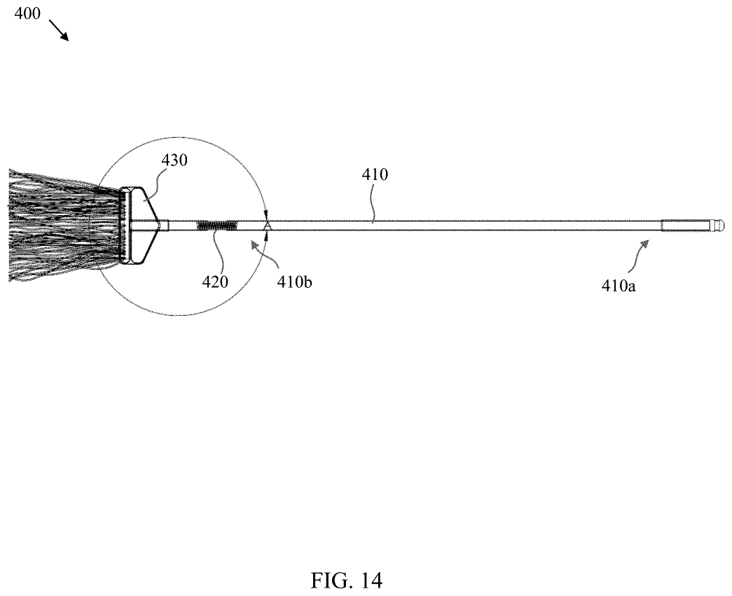

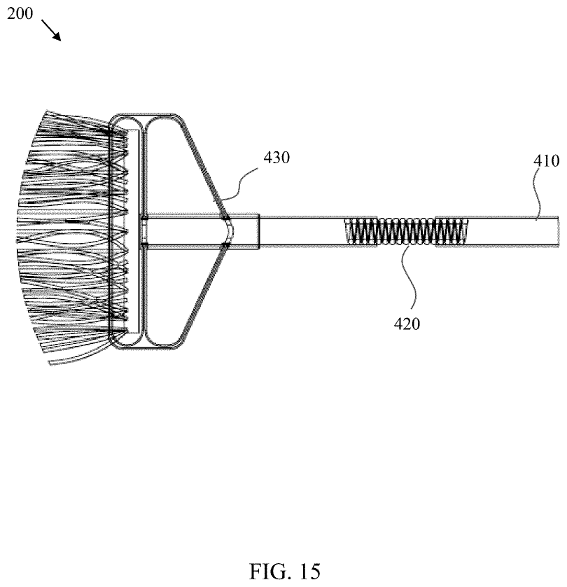

FIG. 13 is a top perspective view of a flexible cleaning apparatus according to another example embodiment of the present general inventive concept, FIG. 14 is a top view of the flexible cleaning apparatus of FIG. 13, and FIG. 15 is an enlarged detail view of section A in FIG. 14.

Referring to FIGS. 13 and 14, the present example embodiment of the flexible cleaning apparatus 400 includes a handle 410 having a first end 410a and an opposing second end 410b, a flexible member 420 coupled to the second end 410b of the handle 410, and a cleaning appendage 430 coupled to the flexible member 420.

In the present embodiment, the cleaning appendage 430 is detachably coupled to a mop or broom. However, the present general inventive concept is not limited thereto.

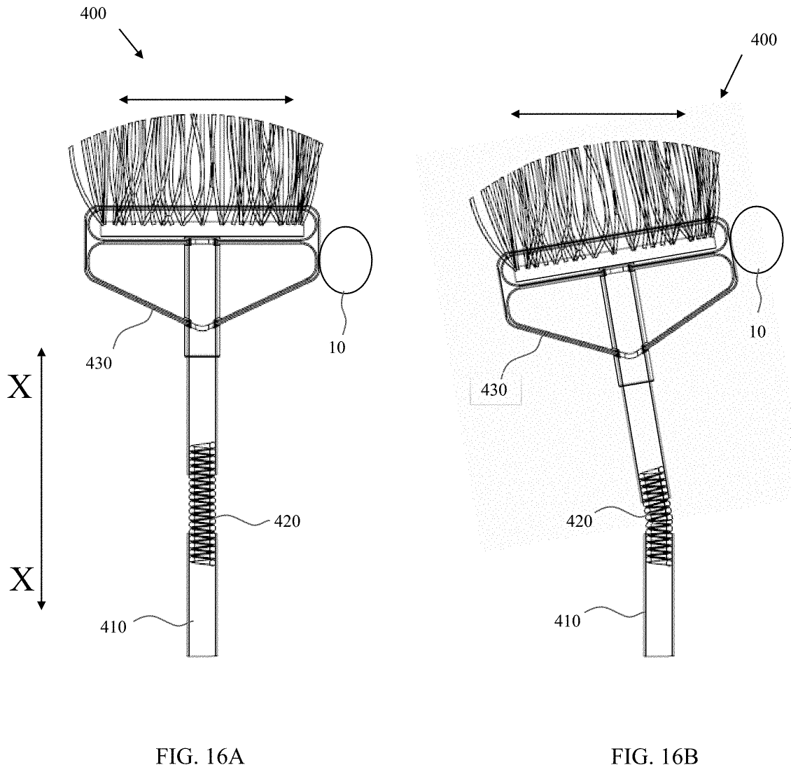

FIGS. 16A-16B are top views of the flexible cleaning apparatus 400 of FIG. 13, while cleaning around an object 10.

Referring to FIGS. 16A-16B, in operation, the flexible member 420 is designed and configured to flex between an angle of about 0 degrees to about 270 degrees to clean around an object 10. However, the present general inventive concept is not limited thereto.

In the present embodiment, the flexible member 420 deflects to allow the cleaning appendage 430 to be disposed at an angle (e.g., from about 0 degrees to about 270 degrees) from the common axis X-X, and thus flex around the object 10 during a cleaning process, as depicted in FIGS. 16A-16B.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A cleaning apparatus for cleaning around an object, comprising:
a handle having a first end and an opposing second end;
a flexible member coupled to the second end of the handle; and
a cleaning appendage coupled to the flexible member,
wherein flexible member allows the cleaning appendage to move omni-directionally when encountering an object.

2. The cleaning apparatus of claim 1, wherein the flexible member allows the cleaning appendage to move between an angle of about 0 degrees to about 270 degrees.

3. The cleaning apparatus of claim 1, wherein each cleaning appendage includes a slit extending along a longitudinal axis configured to detachably affix a cleaning pad.

4. The cleaning apparatus of claim 1, wherein the first end of the handle includes a loop.

5. The cleaning apparatus of claim 1, wherein the handle includes a middle section having a width larger than a width of the first and second ends of the handle for ergonomic benefit.

6. A cleaning apparatus for cleaning around an object, comprising:
a handle having a first end and an opposing second end;
a slit disposed within the handle;
a lock disposed with the slit and movable between a first position and a second position;
a flexible member coupled to the second end of the handle; and
a cleaning appendage coupled to the flexible member,
wherein flexible member allows the cleaning appendage to move omni-directionally when the lock is disposed at the second position.

7. The cleaning apparatus of claim 6, wherein the flexible member allows the cleaning appendage to move between an angle of about 0 degrees to about 270 degrees.

8. The cleaning apparatus of claim 6, wherein each cleaning appendage includes a slit extending along a longitudinal axis configured to detachably affix a cleaning pad.

9. The cleaning apparatus of claim 6, wherein the handle includes a middle section having a width larger than a width of the first and second ends of the handle for ergonomic benefit.

10. The cleaning apparatus of claim 6, wherein a movement of the cleaning appendage is rigid when the lock is in the first position.
